(19) United States
(12) Patent Application Publication
(10) Pub. No.: US 2003/0093523 A1
(43) Pub. Date: May 15, 2003

(54) Method for associating clients with domain name servers

(76) Inventors: Charles D. Cranor, Morristown, NJ (US); Frederick Douglis, Basking Ridge, NJ (US); Zhuoqing Mao, Mountain View, CA (US); Michael Rabinovich, Gillette, NJ (US); Oliver Spatscheck, Randolph, NJ (US); Jia Wang, Summit, NJ (US)

Correspondence Address: AT&T CORP., P.O. BOX 4110, MIDDLETOWN, NJ, 07748, US

(21) Appl. No.: 09/683,074

(22) Filed: Nov. 15, 2001

(51) Int. Cl. G06F 15/16

(52) U.S. Cl. 709/225; 709/203

(57) ABSTRACT

The objective of this invention is to address issues such as the originator problem or the hidden load problem by providing mechanisms in a network having a domain name system for building associations of clients with the domain name servers they use.

### BACKGROUND OF INVENTION

The present invention relates to domain name services in packet-switched networks.

Packet-switched networks, such as networks based on the TCP/IP protocol suite, can be utilized to distribute a rich array of digital content to a variety of different client applications. One of the more popular applications on the Internet today are browsing applications for searching the World Wide Web, e.g. Netscape Navigator or Microsoft Internet Explorer, which utilize the HyperText Transfer Protocol (HTTP) to retrieve documents written in the HyperText Markup Language (HTML) along with embedded content. See, e.g., R. Fielding et al., “Hypertext Transfer Protocol—HTTP/1.1, ” IETF RFC 2616, Network Working Group, 1999, which is incorporated by reference herein. HTML documents, as well as other resources on the Internet such as embedded multimedia content, are addressed by Uniform Resource Locators (URLs), e.g. “http://www.xyz.com/dir/document.html” which identifies an HTML document, “document.html” on server “www.xyz.com” in directory “dir” which may be accessed using the HTTP protocol. See Berners-Lee, T., et al., “Uniform Resource Locators,” IETF RFC 1738, Network Working Group, 1994, which is incorporated by reference herein. Servers/hosts are identified by domain names, e.g. “www.xyz.com”, which are part of a loosely hierarchical naming scheme which are mapped into network IP addresses using the Domain Name Service (DNS). See P. Mockapetris, “Domain names—concepts and facilities,” RFC 1034, November 1987; P. Mockapetris, “Domain names—implementation and specification,” RFC 1035, November 1987; which are incorporated herein by reference. DNS is in essence a distributed database of multiple name servers that maintain and answer queries on mapping between domain names and addresses. Name servers belong to a hierarchy wherein DNS queries are resolved by contacting other name servers and following a delegation/referral chain to an authoritative name server for the queried host. For example, before a client can issue a request for a resource identified in a particular URL, a DNS query must be issued to translate the host name into an IP address that is utilized to establish the connection to the server with the desired resource.

It is often advantageous when distributing digital content across a packet—switched network to divide the duty of answering content requests among a plurality of geographically dispersed servers. Companies such as Akamai Technologies, AT&T, Digital Island, and Speedera provide services—referred to in the art as “content distribution” services—utilizing architectures which dynamically redirect content requests to a cache advantageously situated closer to the client issuing the request. Such network architectures are referred to herein generically as “content distribution networks” or “CDNs” for short. These companies either co-locate caches within Internet Service Providers or deploy the cache servers within their own separate networks for their content provider customers. Content distribution offerings differ in the ways they divide the functions and control over request processing between the customer and the CDN platform. One prevalent method for distributing HTTP requests among replicated Web servers or caches in a CDN is by “load-balancing” DNS. The content distribution service provides an authoritative DNS name server(s) for part or all of the customer's Web site. For example, “www.xyz.com” may be served by the “xyz” company's own server but “images.xyz.com” might be resolved by the CDN. The DNS server of the replicated site or CDN attempts to direct HTTP requests to the closest Web server or cache, and to ensure that no server is overloaded. However, this method faces two fundamental problems. First, the balancing DNS server only knows the identity of the originator of the DNS query at the time of the DNS resolution. This originator is the client DNS server, which may be far away from the HTTP client that will be making the HTTP request. The closest Web server to the client DNS server may not be the same as the closest Web server to HTTP clients. The inventors refer to this as the “originator problem”. Second, the amount of HTTP load that results from a single DNS query may differ by several orders of magnitude. This complicates DNS-based load-balancing decisions, because the balancing DNS server would not know, after resolving one DNS query to a given server, if that server can still accept more load. This problem is referred to as the “hidden load problem.”

### SUMMARY OF INVENTION

The objective of this invention is to address issues such as the originator problem or the hidden load problem by providing mechanisms in a network having a domain name service for building associations of clients with the domain name servers they use. Such associations between the network addresses of clients and domain name servers can be used, for example and without limitation, to estimate hidden loads of queries from different domain name servers without modifications to the domain name service protocol. This is particularly advantageous for replicated sites and content distribution networks that utilize the domain name service to distribute application client requests among a plurality of application servers.

In one embodiment of the invention, special calibrating network addresses are assigned for the purpose of associating clients with their DNS servers. To find which clients use a given DNS server, the CDN's DNS occasionally resolves a DNS query from this server to the calibrating address. The system waits between consecutive calibrating responses long enough to ensure that no previous calibrating responses have been cached. The system can then confidently associate clients that send application requests to the calibrating address with the client's DNS server to which the preceding calibrating response was sent. This mechanism also lets the system measure the hidden load factor for a given client's DNS by observing the load imposed on the calibrating server as a result of sending the calibrating DNS response to this DNS server.

In another embodiment of the invention, the system can alternatively send a calibrating domain name to a client. The calibrating domain name can be for dummy embedded content, e.g. a small object such as a one pixel-by-one pixel transparent graphic file, and can be dynamically generated. The calibrating domain name preferably has information identifying the client or client address encoded in the domain name. The client will need to resolve this name by sending a domain name query, through its client DNS server. The system can then associate the client with the client's DNS server.

In accordance with a third embodiment of the invention, which is a variation on the second embodiment, clients are redirected from a document containing embedded content to the calibrating domain name which is dynamically-generated. Again, the calibrating domain name preferably has information identifying the client or client address encoded in the domain name. Thus, when the client resolves the name, the system can then associate the client with the client's DNS server. The document containing the embedded content advantageously need not be dynamically modified. This technique adds the redirect overhead, but is applicable to a wider range of content distribution network types.

The present invention advantageously can utilize existing standards without change and does not rely on incorrect assumptions regarding data requests and domain name servers. These and other advantages of the invention will be apparent to those of ordinary skill in the art by reference to the following detailed description and the accompanying drawings.

### BRIEF DESCRIPTION OF DRAWINGS

FIG. 1 is an illustrative network architecture, suitable for practice of the present invention.

FIG. 2 is a flowchart of processing performed by a client, a calibrating server, and respective domain name system servers, in accordance with one embodiment of the invention.

FIG. 3 is a conceptual representation of a Web page that has been modified to contain a calibrating URL.

FIG. 4 is a flowchart of processing performed by a client, a calibrating server, and respective domain name system servers, in accordance with a second embodiment of the invention.

FIG. 5 is a conceptual representation of a Web page that has been modified to contain a redirecting URL.

FIG. 6 is a flowchart of processing performed by a client, a redirector server, and respective domain name system servers, in accordance with a third embodiment of the invention.

FIG. 7 is an abstract diagram of the client, the redirector server, the respective domain name system servers, and the content server interacting in accordance with the embodiment shown in FIG. 6, in the context of DNS, IP addresses and HTTP requests.

### DETAILED DESCRIPTION

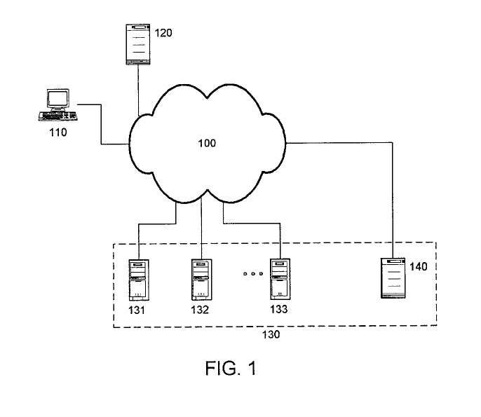

FIG. 1 is an illustrative network architecture, suitable for practice of the present invention. A client 110 is connected to a packet-switched network 100, e.g. the Internet, which provides access to a plurality of content servers such as servers 131, 132, . . . 133. For example and without limitation, content servers 131, . . . 133 can be Web servers that respond to HTTP requests by serving Web pages and other content to clients running Web browser applications. The content servers 131, . . . , 133 are assumed to store some replicated content. The content servers 131, . . . 133, for illustration only, can be part of a content distribution network, represented abstractly in FIG. 1 as 130. Utilizing any of a variety of known techniques, content requests from client 110 may be redirected to one of the content servers 131, . . . 133, preferably to a server that is the “closest” to the client 110. See, e.g., U.S. Pat. No. 6,108,703, “Global Hosting System,” to Leighton et al.; U.S. Pat. No. 6,185,598, “Optimized Network Resource Location,” to Farber et al., which are incorporated by reference herein. The content server then responds to the HTTP request utilizing a cached copy of the content. Each content server can be a single cache server or can have a switch providing access to a plurality of cache servers for further load balancing, not shown in FIG. 1.

Each network entity has access to one or more domain name system (DNS) servers. The client's DNS server is represented by 120 in FIG. 1. The DNS server authoritative for the content servers 131, . . . 133 is represented by 140 in FIG. 1. It is assumed for purposes of the invention that the domain name service, or an equivalent network service, is utilized to distribute client requests to one out of the plurality of replicated content servers. It should be noted that although the present invention is described with particular reference to content distribution networks, the mechanisms disclosed for solving the originator and hidden load problems have more general applicability than CDNs. The present invention is, for example and without limitation, equally applicable to a replicated Web site or any situation in which the association between hosts and local DNS servers is to be obtained. Moreover, although described with particular reference to HTTP Web applications, the invention is equally applicable to other types of Internet applications that utilize DNS.

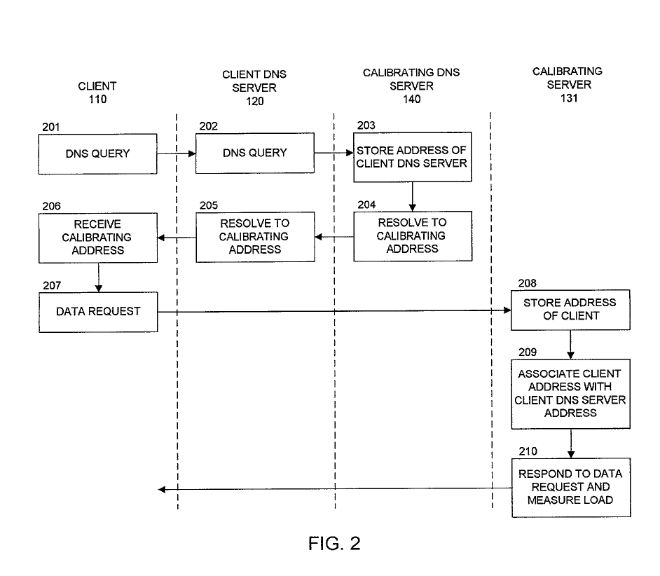

In accordance with one embodiment of the invention, FIG. 2 is a flowchart of processing performed by a client, what is referred to by the inventors as a “calibrating” server, and respective domain name system servers. The calibrating server is a server that has been assigned a special network address, referred to by the inventors as a “calibrating” address. For example, where the packet-switched network 100 is an Internet Protocol (IP)—based network, the calibrating address would be a dedicated IP address designated as a “calibrating” IP address for the purpose of associating clients with their respective DNS servers. These IP addresses may belong to actual distinct servers used solely for the calibration purpose or to regular servers, which in this case would have both a regular IP address as well as a calibrating IP address(es). In the following example, server 131 in FIG. 1 is designated as a calibrating server with a calibrating address.

With reference to FIG. 2, the client 110 at step 201 attempts to resolve the domain name of content hosted by the CDN by sending a lookup request to the local client DNS 120 . The client DNS server 120 will, depending on the particular details of the domain name service implementation, contact servers in the domain name system hierarchy in an attempt to answer the lookup request—which may entail contacting a root DNS server to get a referral or a chain of referrals to the address of an authoritative DNS server. At step 202, the client DNS server 120 sends a lookup request to the DNS server 140 which is authoritative for the domain of the content servers and the calibrating server 131. Normally, the DNS server 140 simply responds to the request with the address of one of the content servers. Occasionally, where it is desired to find out which clients are using a given DNS server, the DNS server 140 can resolve a DNS query from the client DNS server 120 to the calibrating address. This domain name system response is referred to by the inventors as a “calibrating” response, and should typically be assigned a zero TTL to avoid caching of previous calibrating responses. At step 203, the DNS server 140 logs an association between the identity of the client's local DNS server 120 and the calibrating address, e.g. by storing the IP address of the client's DNS server 120. The calibrating response is returned to the client's DNS server 120 at step 204. In one instantiation, the DNS server can dynamically insert the calibrating address, preferably waiting between consecutive calibrating reponses long enough to ensure that no client DNS or HTTP client has cached previous calibrating responses. At steps 205 and 206, the calibrating response is returned to the client 110 which utilizes the calibrating address to issue the data request, at step 207. Upon receiving the data request issued from the client address to the calibrating address, the system can then confidently associate the client that sends the data request with the DNS server to which the preceding calibrating response was sent. Accordingly, at steps 208 and 209, the client address can be stored and associated with the client DNS server address, previously stored. At step 210, the calibrating server or another content server can then be designated to respond to the data request.

It should be noted that this mechanism also lets the system measure the hidden load factor for a given client's DNS by observing the load imposed on the calibrating server as a result of sending the calibrating DNS response to this DNS server. Using this mechanism, the system can gradually build a database of the hidden load factors for client DNS servers.

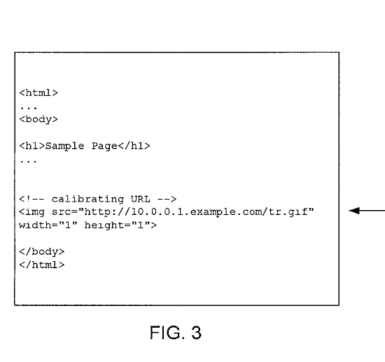

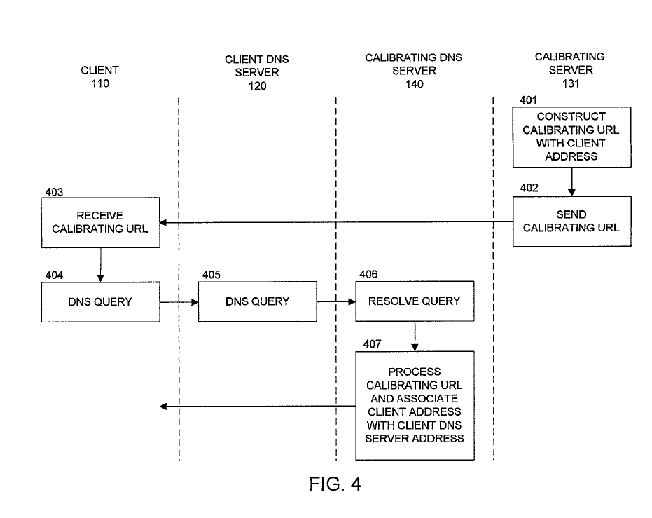

In accordance with a second embodiment of the invention, FIG. 4 is a flowchart of processing performed by a client, a content server, and respective domain name system servers. The inventors refer to this as a complimentary “calibrating name” mechanism. In a content distribution network that delivers both embedded content and data pages containing the embedded content, the mechanism would work as follows. The content servers 131, . . . , 133 can dynamically insert into contained pages a “dummy” embedded object whose URL has what the inventors refer to as a special “calibrating” domain name. For example and without limitation, FIG. 3 sets forth a conceptual representation of an HTML Web page that has been modified to contain a calibrating domain name. The dummy object is preferably invisible, e.g. by designating it as one byte in size. The calibrating domain name also preferably encodes the identity of the client that requested the contained page, e.g. by embedding the network address of the client in the domain name. For example, as shown in FIG. 3, the dummy URL could have a form like “http://10.0.0.1.example.com/tr.gif” where 10.0.0.1 is the IP address for the Web client and “tr.gif” is the filename for the dummy object.

With reference again to FIG. 4, at step 401, the content server 131 constructs the calibrating URL using the network address of the client. At step 402, the content server 131 sends the calibrating URL in the contained page to the client 110 which receives the calibrating URL at step 403. The client 110 will need to resolve the calibrating name. So, at step 404, the client issues a DNS query to its DNS server 120, as described above. At step 405, the DNS server 120 manages to contact the DNS server 140, which is the authoritative server for the domain set forth in the calibrating URL. The DNS server 140, in resolving the DNS query for this domain name at step 406, then recognizes that this query must come from this client's DNS. The DNS server 140 knows that the next DNS query for this name, which the inventors refer to as a “calibrating query,” after it has been handed out by the system must emanate from the client's DNS server. Thus, at step 407, the DNS server 140 can process the calibrating URL and associate the client's address with the client DNS server address. The CDN's DNS server 140 will have both the IP address of the client DNS server (which is the originator of the query and the HTTP client (from the DNS name being resolved). It should be noted that the domain name need not explicitly encode the actual network address of the client. Alternatively, the client address can be stored ahead of time and some random designation embedded in the calibrating URL and used to correlate the calibrating DNS query with the client address.

The “calibrating names” method allows the estimation of the number of HTTP requests that follow a DNS query from a given client DNS server, based on the number of calibrating queries that come from that client DNS server.

Where the content distribution network delivers only embedded content, the above mechanism can be advantageously modified as follows. An arbitrary embedded object can be selected for calibration. Instead of serving this object directly to clients, a content server 131 could use a redirect feature, such as the HTTP redirect command, to redirect the client to a dynamically generated calibrating URL. This URL would preferably have a domain name that embeds the identity of the client, e.g. encoding the client's IP address as described above. As in the case above, the client 110 will need to resolve this name by sending the calibrating DNS query, through its client DNS server 120, to the CDN DNS server 140. The latter will be able to associate the HTTP client with the client's DNS server similar to the first case. This technique adds the HTTP redirect overhead but it is applicable to a wider range of content distribution network types. It has the advantage that the encompassing document page does not have to be dynamically modified.

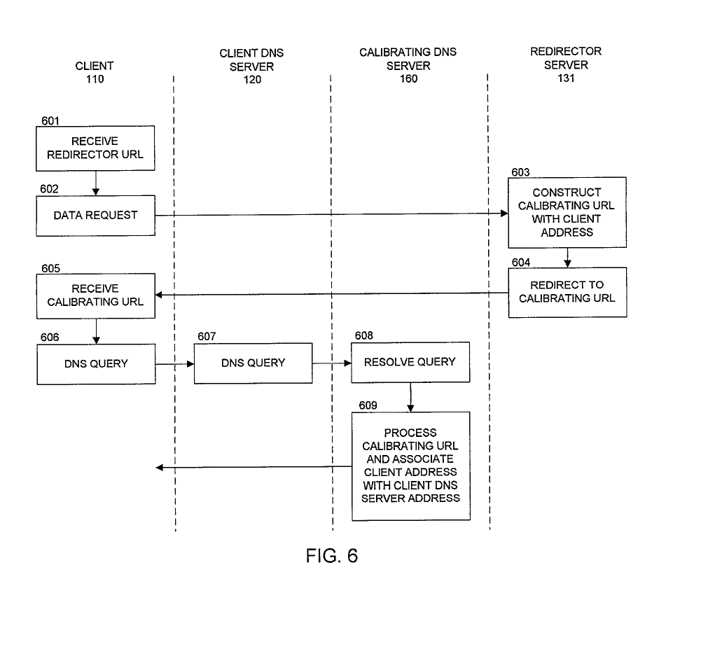

Thus, in accordance with this third embodiment of the invention, FIG. 6 is a flowchart of processing performed by a client, a redirector server, and respective domain name system servers. At step 401, the client receives a container document with a reference pointing to embedded content on server 131. In this example, server 131 in FIG. 1 is designated as the redirector server and merely responds to all data requests, at step 602, with a redirect to a calibrating domain name, as described above. The redirector server 131 accomplishes this by encoding the identity of the client in the calibrating domain name, e.g. by embedding the network address of the client in the domain name at step 603. At step 604, the redirector server 131 redirects the client to the calibrating domain name. Then at steps 605 to 609, the client proceeds to resolve the calibrating domain name, as described above with reference to steps 403 to 407 in FIG. 4. Thus, the calibrating DNS server 140 can utilize the calibrating domain name to associate the embedded client with the DNS server 120 issuing the calibrating query. Whenever a client attempts to load the dummy embedded content, the mechanism allows the matching of the address of the local domain name system server resolving hostnames on behalf of the client with the address of the client itself. Note that the approach is fully deterministic. It collects one association each time a new client requests a container document with an embedded object. Multiple document requests on the same site or subsequent visits to the same document page may result in repeated retrievals of the calibrating object depending on the client's caching policy.

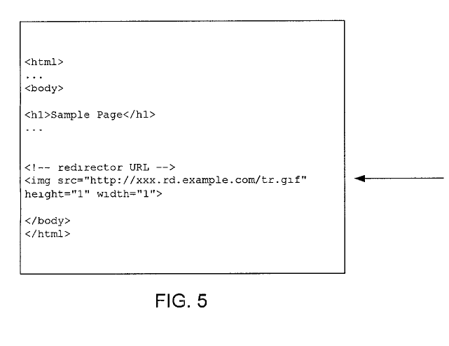

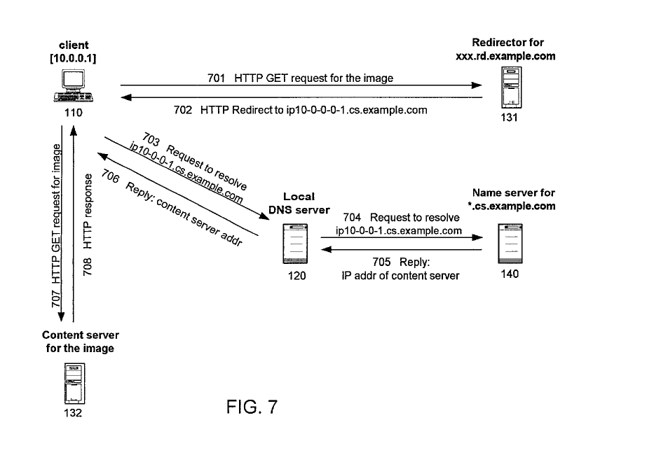

FIG. 5 and FIG. 6 illustrate this embodiment of the invention in the specific context of Web page requests and HTTP redirection. FIG. 5 sets forth a conceptual representation of an exemplary HTML Web page that has been modified to contain a URL to the redirector server. The URL should be modified such that it is unlikely to be used as a conventional URL. For example, to permit the system to easily account for hits redirected from different Websites, each participating Website can utilize a site identifier encoded in “xxx” in the domain name “xxx.rd.example.com”. This advantageously allows additional Web pages and Web sites to be added to the system without making any changes to the Web or DNS server configuration. With reference to FIG. 7, at step 701 the client 110 attempts to get the dummy image from “xxx.rd.example.com”—the HTTP redirector 131. Rather than serving the dummy image, the redirector 131 at step 702 determines the client's address and issues an HTTP redirect to “ipCLI.cs.example.com” where “CLI” is replaced with the IP address of the client. At step 703, the client 110 contacts its local DNS server 120 to resolve this domain name. The client's local DNS server 120 attempts to resolve “ipCLI.cs.example.com” by sending a DNS request to the authoritative DNS server 140. At this point, the authoritative DNS server 140 logs the IP address of the local DNS server 120 and the client IP address embedded within the query. At step 705, it sends the address of the content server hosting the dummy image back to the local client's local DNS server 120. This resolution is passed on to the client 110, at step 706, which proceeds to retrieve the image from the content server at steps 707 and 708.

The HTTP redirector can be a very simple server: e.g., without limitation, a single-threaded, non-blocking short program that responds to all Web requests with a “307 Moved Temporarily” HTTP redirect. The small size and overhead of the redirector makes it highly reliable and more responsive than a standard Web server. Moreover, the redirector can advantageously log client requests. This information can be correlated with the DNS and Web server logs to obtain the hidden load factors. Statistics on client browsing characteristics can also be gathered from the HTTP headers in the redirector log.

The additional overhead the above technique imposes on Web client performance is the retrieval of the dummy transparent image, including HTTP redirect and extra DNS requests. Because the image is transparent, it does not visually affect the page. Furthermore, the image is small in size—typically 43 bytes—which keeps the added delay to a minimum. Also, if the image is included at the end of the HTML page containing it, the browsers will normally request it last. Thus, the extra latency associated with the image is usually hidden from the user's Web browsing experience. Another advantage of the small size of the image is that when the image is not available for download, it does not affect the visual appearance of the Web page at all.

The present invention has the advantages of efficiency, nonintrusiveness and accuracy. The present invention advantageously utilizes existing standards; no new ones are needed. The invention advantageously does not rely on assumptions regarding HTTP requests and DNS that may turn out to be incorrect. For example, it has recently been suggested to:

(1) associate HTTP requests with the DNS request that occurred a short time earlier;

(2) associate a HTTP client with the DNS server that has a common high-level DNS name or which belongs to the same autonomous system;

(3) associate a HTTP client with the DNS server such that their longest matched

IP address prefix in the routing tables (e.g. BGP tables) are the same. The reasoning behind the first method is that a Web interaction involves a DNS query followed by an HTTP request. Unfortunately, DNS caching muddies this scenario. Many HTTP requests reuse the same DNS query and occur long after it. Conversely, an unrelated DNS query can easily occur just prior to an unrelated HTTP request and be mistakenly associated with the latter. The second method assumes that HTTP clients and their DNSs would belong to the same domain and/or autonomous system. However, this assumption may not hold in some cases, and in other cases, the domain or AS may have more than one DNS server, raising a problem of how to apportion clients among these DNS servers. The third method is similar to the “common AS” method above and assumes that HTTP clients and their DNSs are located on the same network and therefore will have common prefixes in their IP addresses. Again, a large network may partition its HTTP clients among multiple client DNSs and a small network may use a DNS server from another network, in which case HTTP clients in the first network may not have an IP prefix that matches their DNS server. The present invention does not share any of the above-mentioned disadvantages.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. Embodiments within the scope of the present invention also include device readable media and computer readable media having executable program instructions or data fields stored thereon. Such computer readable media can be any available media which can be accessed by a general purpose or special purpose computing device.

It is to be understood that the embodiments shown and described herein are only illustrative of the principles of the present invention and that various modifications may be implemented by those skilled in the art without departing from the scope and spirit of the invention. For example, the detailed description has been presented particularly in the context of DNS, HTTP, and content distribution networks; however, as alluded to above, the principles of the present invention could be extended to other protocols and other applications. Such an extension could be readily implemented by one of ordinary skill in the art given the above disclosure.

1. A method of associating clients with domain name system servers comprising the steps of:
receiving a domain name system query from a domain name system server requesting resolution of a calibrating domain name;
identifying a client based on the calibrating domain name;
associating the client with the domain name system server.

2. The invention of claim 1 wherein the client is identified by retrieving a network address encoded in the calibrating domain name.

3. The invention of claim 2 wherein the calibrating domain name points to a dummy object.

4. The invention of claim 2 wherein the network address is encoded in the calibrating domain name by a redirector.

5. The invention of claim 3 wherein the client is associated with the domain name system server by associating the network address of the client with the network address of the domain name system server.

6. The invention of claim 4 wherein the network addresses are Internet Protocol addresses and wherein the domain name system server is a DNS server.

7. A method of associating clients with domain name system servers comprising the steps of:
receiving a data request from a client with a network address;
encoding the client's network address in a calibrating domain name;
redirecting the client to the calibrating domain name, whereby the calibrating domain name can be utilized to associate the client with a domain name system server when a domain name system query is issued by the client.

8. The invention of claim 7 wherein the calibrating domain name points to a dummy object.

9. The invention of claim 8 wherein the data request is an HTTP request and redirection is accomplished using an HTTP redirect.

10. The invention of claim 9 wherein the client is associated with the domain name system server by associating the network address of the client with the network address of the domain name system server.

11. The invention of claim 10 wherein the network addresses are Internet Protocol addresses and wherein the domain name system server is a DNS server.

12. A method of associating clients with domain name system servers comprising the steps of:
receiving a data request from a client directed to a calibrating network address;
identifying a domain name system server by the calibrating network address, wherein the calibrating network address was provided to the domain name system server in response to a domain name system query issued by the domain name system server;
associating the client with identified domain name system server.

13. The invention of claim 12 wherein the data request is an HTTP request.

14. The invention of claim 13 wherein the client is associated with the domain name system server by associating the network address of the client with the network address of the domain name system server.

15. The invention of claim 14 wherein the network addresses are Internet Protocol addresses and wherein the domain name system server is a DNS server.
